(19) United States
(12) Patent Application Publication
(10) Pub. No.: US 2010/0067265 A1
(43) Pub. Date: Mar. 18, 2010

(54) ELECTRONIC SYSTEM AND POWER SUPPLY DEVICE THEREOF

(75) Inventors: Chi-Nan Lu, Hsichih (TW); Ruey-Ching Shyu, Hsichih (TW)

Correspondence Address: EGBERT LAW OFFICES, 412 MAIN STREET, 7TH FLOOR, HOUSTON, TX, 77002, US

(73) Assignee: ACER INCORPORATED, Hsichih (TW)

(21) Appl. No.: 12/484,012

(22) Filed: Jun. 12, 2009

(30) Foreign Application Priority Data
Sep. 16, 2008 (TW) 097135533

(51) Int. Cl. H02M 1/36

(52) U.S. Cl. 363/49

(57) ABSTRACT

In an electronic system and a power supply device thereof, the power supply device supplies electric power to an electronic device in the electronic system. When the electronic device is shut down, the electronic device transmits a shutdown signal to the power supply device, so that the power supply device stops supplying electric power to the electronic device. And, when the electronic device is switched on, the electronic device transmits a start signal to the power supply device, so that the power supply device starts supplying electric power to the electronic device. Therefore, power consumption by the power supply device when the electronic device is shut down can be reduced.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to an electronic system and a power supply device thereof, and more particularly to a technical field that enables a power supply device to start or stop a power supply function thereof when an electronic system is switched on or shut down.

2. Description of Related Art Including Information Disclosed Under 37 CFR 1.97 and 37 CFR 1.98.

With the rising sense of environmental protection, more and more consumers hope that power consumed by electronic systems can be further reduced. Most of the currently available electronic devices use an alternating current to direct current (AC/DC) power supply device to supply electric power thereto. However, conventionally, when an electronic device is switched off or in a standby state, the power supply device still keeps supplying electric power to the electronic device to result in unnecessary power consumption. While a user can unplug the power supply device from the electronic device, it is inconvenient for the user to do so.

### BRIEF SUMMARY OF THE INVENTION

A primary object of the present invention is to provide an electronic system and a power supply device that enables reduced power consumption by the power supply device when an electronic device of the electronic system is shut down.

To achieve the above and other objects, the power supply device according to the present invention for supplying electric power to an electronic device comprises an alternating current to direct current (AC/DC) converting circuit, a voltage converting circuit, and a starting circuit. The AC/DC converting circuit receives an AC voltage and converts the received AC voltage into a DC voltage. The voltage converting circuit receives the DC voltage and generates an output voltage to the electronic device. The starting circuit is electrically connected to and between the AC/DC converting circuit and the voltage converting circuit. When the starting circuit receives a start signal generated by the electronic device, the starting circuit is closed to allow the voltage converting circuit to receive the DC voltage; and when the starting circuit receives a shutdown signal generated by the electronic device, the starting circuit is opened to prevent the voltage converting circuit from receiving the DC voltage.

The power supply device according to the present invention further comprises a cable having a connector provided thereon for electrically connecting the power supply device to the electronic device via the connector. And, the start signal or the shutdown signal is transmitted from the electronic device to the starting circuit via the cable.

In the present invention, the connector for connecting the power supply device to the electronic device comprises at least three pins.

In an alternative embodiment of the present invention, the power supply device further comprises a flat cable for electrically connecting to the electronic device; and the start signal or the shutdown signal is transmitted to the starting circuit via the flat cable.

To achieve the above and other objects, the electronic system according to the present invention comprises an electronic device and a power supply device for supplying electric power to the electronic device. The power supply device comprises an AC/DC converting circuit, a voltage converting circuit, and a starting circuit. The AC/DC converting circuit receives an AC voltage and converts the received AC voltage into a DC voltage. The voltage converting circuit receives the DC voltage and generates an output voltage to the electronic device. The starting circuit is electrically connected to and between the AC/DC converting circuit and the voltage converting circuit. When the electronic device is switched on, it transmits a start signal to the starting circuit, so that the starting circuit is closed to allow the voltage converting circuit to receive the DC voltage; and when the electronic device is shut down, it transmits a shutdown signal to the starting circuit, so that the starting circuit is opened to prevent the voltage converting circuit from receiving the DC voltage.

In an embodiment of the present invention, the start signal or the shutdown signal is generated by a power switch of the electronic device.

In another embodiment of the present invention, when a power switch of the electronic device is triggered to thereby start or shut down the electronic device, an embedded controller of the electronic device generates the start signal or the shutdown signal.

In a further embodiment of the present invention, the electronic device comprises a screen and runs an operating system to display an operating interface on the screen. When a user shuts down the electronic device via the operating interface, an embedded controller of the electronic device generates the shutdown signal.

### BRIEF DESCRIPTION OF THE SEVERAL VIEWS OF THE DRAWINGS

The structure and the technical means adopted by the present invention to achieve the above and other objects can be best understood by referring to the following detailed description of the preferred embodiments and the accompanying drawings.

FIG. 1 is a schematic view of a diagram of a power supply device according to an embodiment of the present invention.

FIG. 2 is a perspective view showing a first embodiment of an electronic system according to the present invention.

FIG. 3 is a block diagram of a second embodiment of the electronic system according to the present invention.

### DETAILED DESCRIPTION OF THE INVENTION

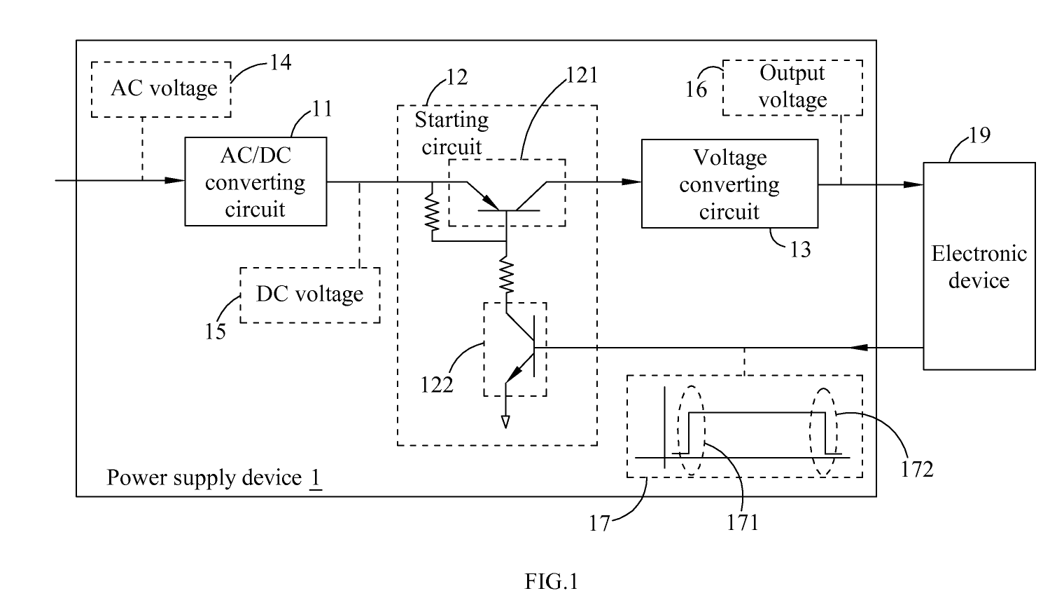

Referring to FIG. 1, there is a schematic diagram of a power supply device 1 according to an embodiment of the present invention. As shown, the power supply device 1 comprises an alternating current to direct current (AC/DC) converting circuit 11, a starting circuit 12, and a voltage converting circuit 13. The AC/DC converting circuit 11 receives an AC voltage 14 and converts the AC voltage 14 into a DC voltage 15. The voltage converting circuit 13 receives the DC voltage 15 to generate an output voltage 16 for supplying to an electronic device 19 as a working power supply thereof. The starting circuit 12 is electrically connected to and between the AC/DC converting circuit 11 and the voltage converting circuit 13. For the purpose of easy to explain an on/off function thereof, the starting circuit 12 in the illustrated embodiment only consists of two transistors 121, 122 and a plurality of resistors. However, it is understood the starting circuit 12 is not limited to the illustrated structure but may comprise other related electronic elements as necessary. The power supply device 1 further comprises a cable or a flat cable for coupling with the electronic device 19. The cable comprises a connector, via which the cable is electrically connected to the electronic device 19. The connector of the cable preferably comprises at least three pins, and the electronic device 19 may transmit a control signal 17 to the starting circuit 12 via the cable or the flat cable.

When the starting circuit 12 receives a start signal 171 generated by the electronic device 19, that is, a rising edge signal in the control signal 17 indicating a level rising from low to high, the transistors 121, 122 are turned on, that is, the starting circuit 12 is closed to allow the voltage converting circuit 13 to receive the DC voltage 15. Therefore, the electronic device 19 may receive the output voltage 16 to perform desired operations.

On the other hand, when the starting circuit 12 receives a shutdown signal 172, that is, a falling edge signal in the control signal 17 indicating a level falling from high to low, the transistors 121, 122 are turned off and the starting circuit 12 is opened to prevent the voltage converting circuit 13 from receiving the DC voltage 15.

With these arrangements, when the electronic device 19 is shut down, the shutdown signal 172 is transmitted to open the starting circuit 12, so that the voltage converting circuit 13 could not receive the DC voltage 15 and the power supply device 1 no longer outputs electric power. When the power supply device 1 of the present invention does not supply power, the continuous power consumption by the voltage converting circuit may be avoided. Therefore, the power supply device 1 is superior compared to the conventional power supply device. On the other hand, when the electronic device 19 is switched on, the start signal 171 is transmitted to close the starting circuit 12, so that the power supply device 1 may supply electric power to the electronic device 19.

The electronic device 19 may be a desktop computer, a portable computer, or a television set, or any electric appliance that comprises an externally connected AC/DC power supply device or a built-in AC/DC power supply device. The voltage converting circuit 13 may comprise a pulse-width modulation (PWM) controller, a transformer, and a rectifying circuit. The transformer comprises a primary side at where the DC voltage 15 is received, and a secondary side at where an induction current is output. The rectifying circuit is connected to the secondary side of the transformer for converting the induction current to generate the output voltage 16. The PWM controller outputs a level signal to the transformer, and is electrically connected to the starting circuit 12.

In the illustrated embodiment of the present invention, while two transistors are used to implement the function of closing and opening the starting circuit, and rising edge signal and falling edge signal are used as start signal and shutdown signal, respectively, it is understood the starting circuit may be closed and opened in other manners and the start signal and the shutdown signal may be in other forms without being restricted to the illustrated embodiment.

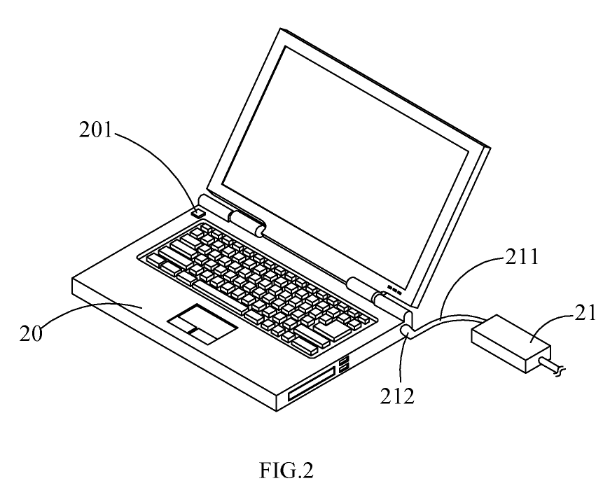

Referring to FIG. 2, there is a perspective view showing a first embodiment of an electronic system according to the present invention. In the illustrated first embodiment thereof, the electronic system comprises a portable computer 20 as an electronic device thereof. The portable computer 20 is electrically connected to a power supply device 21 via a connector 212 on a cable 211 of the power supply device 21. The connector 212 comprises three pins (not shown). Among the three pins, the first and the second one are used to apply a positive and a negative voltage, respectively, and the third one is used to transmit the start signal or the shutdown signal. When a user pushes a power switch 201 on the portable computer 20 to switch on the same, the user's movement of pushing the power switch 201 would cause a level signal at the third pin to change from low to high level and then maintain at the high level. For example, when the power switch 201 is pushed, a battery of the portable computer 20 and the third pin on the connector 212 of the power supply device 21 are electrically connected with one another.

The power switch 201 may comprise a latch for maintaining the level signal at the third pin at the high level. As the operating principle described with reference to FIG. 1, when a starting circuit in the power supply device 21 receives a rising edge signal indicating a level rising from low to high, the power supply device 21 is caused to supply electric power to the portable computer 20, so that the portable computer 20 may use the electric power supplied from the power supply device 21 to perform different operations and charge the battery.

Similarly, when the power switch 201 is pushed again to shut down the portable computer 20, the level signal at the third pin of the connector 212 is changed from high to low, bringing the power supply device 21 to stop supplying power.

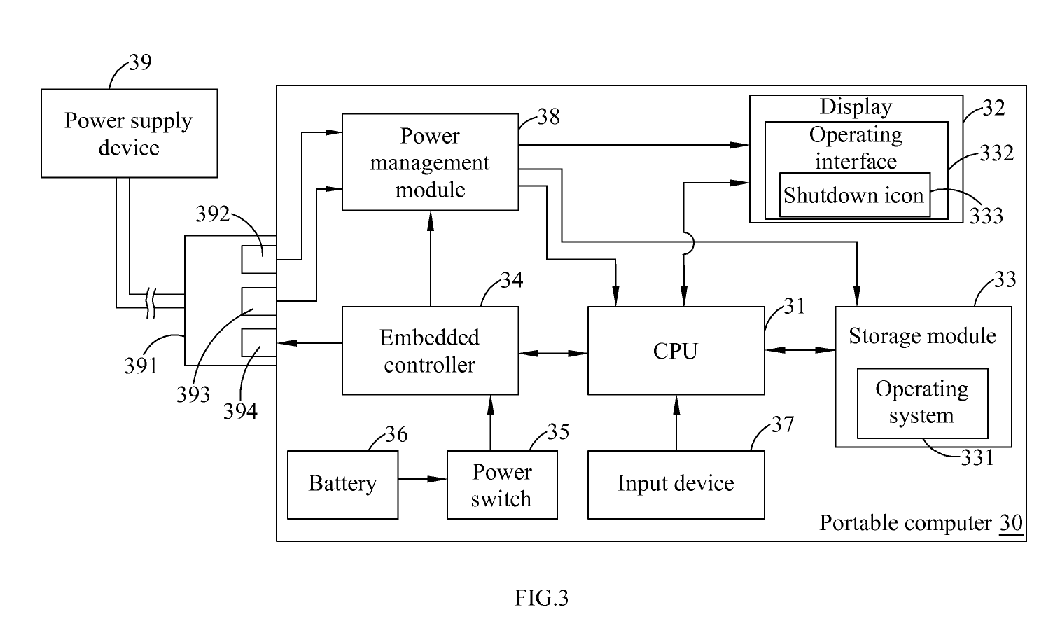

FIG. 3 is a block diagram of a second embodiment of the electronic system according to the present invention. As shown, in the second embodiment, the electronic system comprises a portable computer 30 as an electronic device thereof. The portable computer 30 comprises a central processing unit (CPU) 31, a display 32, a storage module 33, an embedded controller (EC) 34, a power switch 35, a battery 36, an input device 37, and a power management module 38. The storage module 33 comprises at least an operating system 331 stored thereon. When a user pushes the power switch 35, the battery 36 is caused to supply electric power to the embedded controller 34, so that the embedded controller 34 is enabled to carry on a power supply procedure for supplying electric power to electronic elements in the portable computer 30, such as the CPU 31, the display 32, and the storage module 33. Since the above-mentioned power supply procedure is known in the art, it is not discussed in details herein. Thereafter, the CPU 31 reads the operating system 331 from the storage module 33 and runs the operating system 331 to thereby drive the display 33 to show an operating interface 332 of the operating system 331, and the user may use the input device 37 to control the operating interface 332.

On the operating interface 332, there is a shutdown icon 333. When the user uses the input device 37 to trigger the shutdown icon 333 to shut down the portable computer 30, the CPU 31 will run a shutdown procedure and finally outputs an indicating signal to the embedded controller 34, so that the embedded controller 34 stops the power management module 38 from supplying electric power to the electronic elements and thereby shuts down the portable computer 30. In the second embodiment of the electronic system of the present invention, the portable computer 30 is connected to a power supply device 39. The power supply device 39 comprises a connector 391, on which a first pin 392 and a second pin 393 are electrically connected to the power management module 38, and a third pin 394 is electrically connected to the embedded controller 34. With these arrangements, whenever the user pushes the power switch 35 to switch on or shut down the portable computer 30, or triggers the shutdown icon 333 to shut down the portable computer 30, the embedded controller 34 will generate a corresponding start signal or shutdown signal to the third pin 394 on the connector 391 of the power supply device 39.

While the electronic system according to the present invention has been described with some portable computers as preferred embodiments thereof, it is understood the electronic system of the present invention is not limited to portable computers but maybe a television set, for example, which may be switched on or off by triggering a power switch on the television set or a key on a corresponding remote controller. The power supply device of the present invention may also be connected to the television set. And, based on the same operating principle as described above, the power supply device will start or stop supplying electric power to the television set when the latter is switched on or off. That is, the electronic device for the electronic system of the present invention may be any one of a desktop computer, a portable computer, a television, and any other electric appliance that comprises an externally connected or a built-in AC/DC power supply device, which all are fallen in the scope of the invention that is seeking for protection.

In brief the electronic system of the present invention allows a user to shut down an electronic device without the need of manually unplugging the power supply device from a power supply socket. The power supply device according to the present invention may receive a shutdown signal from the electronic device and stop operating the voltage converting circuit thereof according to the shutdown signal. Therefore, power consumption by the power supply device when the electronic device is shut down is reduced.

The present invention has been described with some preferred embodiments thereof and it is understood that many changes and modifications in the described embodiments may be carried out without departing from the scope and the spirit of the invention that is intended to be limited only by the appended claims.

1. A power supply device for supplying electric power to an electronic device, comprising:
an AC/DC converting circuit for receiving an AC voltage and converting the received AC voltage into a DC voltage;
a voltage converting circuit for receiving the DC voltage and generating an output voltage to the electronic device; and
a starting circuit being electrically connected to and between the AC/DC converting circuit and the voltage converting circuit;
wherein when the starting circuit receives a start signal generated by the electronic device, the starting circuit is closed to allow the voltage converting circuit to receive the DC voltage; and
wherein when the starting circuit receives a shutdown signal generated by the electronic device, the starting circuit is opened to prevent the voltage converting circuit from receiving the DC voltage.

2. The power supply device as claimed in claim 1, further comprising;
a cable, being comprised of a connector for electrically connecting to the electronic device, wherein the start signal or the shutdown signal is transmitted from the electronic device to the starting circuit via the cable.

3. The power supply device as claimed in claim 2, wherein the connector comprises at least three pins, where one pin transmits the start signal or the shutdown signal.

4. The power supply device as claimed in claim 1, further comprising:
a flat cable electrically connected to the electronic device, wherein the start signal or the shutdown signal is transmitted from the electronic device to the starting circuit via the flat cable.

5. The power supply device as claimed in claim 1, wherein the electronic device is selected from the group consisting of a desktop computer, a portable computer, and a television set.

6. An electronic system, comprising:
an electronic device; and
a power supply device being comprised of an AC/DC converting circuit, a voltage converting circuit, and a starting circuit, the AC/DC converting circuit receiving an AC voltage and converting the received AC voltage into a DC voltage, the voltage converting circuit receiving the DC voltage and generating an output voltage to the electronic device, and the starting circuit being electrically connected to and between the AC/DC converting circuit and the voltage converting circuit;
wherein when the electronic device is switched on, a start signal is transmitted from the electronic device to the starting circuit, so that the starting circuit is closed to allow the voltage converting circuit to receive the DC voltage; and
wherein when the electronic device is shut down, a shutdown signal is transmitted from the electronic device to the starting circuit, so that the starting circuit is opened to prevent the voltage converting circuit from receiving the DC voltage.

7. The electronic system as claimed in claim 6, wherein the power supply device further comprises:
a cable, having a connector for electrically connecting to the electronic device, wherein the start signal or the shutdown signal is transmitted from the electronic device to the starting circuit via the cable.

8. The electronic system as claimed in claim 7, wherein the connector comprises at least three pins, one pin transmitting the start signal or the shutdown signal.

9. The electronic system as claimed in claim 6, wherein the power supply device further comprises:
a flat cable electrically connected to the electronic device, wherein the start signal or the shutdown signal is transmitted from the electronic device to the starting circuit via the flat cable.

10. The electronic system as claimed in claim 6, wherein the start signal or the shutdown signal is generated by a power switch of the electronic device.

11. The electronic system as claimed in claim 6, wherein when a power switch of the electronic device is triggered to thereby switch on or shut down the electronic device, an embedded controller of the electronic device generates the start signal or the shutdown signal.

12. The electronic system as claimed in claim 6, wherein the electronic device comprises a screen and is able to run an operating system to display an operating interface on the screen; whereby when a user shut down the electronic device via the operating interface, an embedded controller of the electronic device generates the shutdown signal.

13. The electronic system as claimed in claim 6, wherein the electronic device is selected from the group consisting of a desktop computer, a portable computer, and a television set.
